(19) United States
(12) Patent Application Publication
(10) Pub. No.: US 2010/0053978 A1
(43) Pub. Date: Mar. 4, 2010

(54) Radiating semi-conductor light

(76) Inventor: Han-Ming Lee, Hsin Chu City (TW)

Correspondence Address: Han-Ming Lee, P.O. Box 7-820, Taipei, TW

(21) Appl. No.: 12/229,589

(22) Filed: Aug. 26, 2008

(51) Int. Cl. F21V 3/00

(52) U.S. Cl. 362/311.01

(57) ABSTRACT

The present invention provides a radiating semi-conductor light, wherein a lower light housing is enveloped in the head of the chip cup screw for arrangement of two conductive plates, upper light housing, chip and conductive wires, the upper light housing is provided for silicone filling and light cover fixing to protect the chip and allow a radiating nut to thread through the bottom of the chip cup screw for locking and positioning, the heat of the chip on the chip cup can transfer to the radiating nut below for effective and rapid industrial use of radiation

### BACKGROUND OF THE INVENTION

(a) Field of the Invention

The present invention provides a radiating semi-conductor light, wherein a lower light housing is enveloped in the head of the chip cup screw for arrangement of two conductive plates, upper light housing, chip and conductive wires, the upper light housing is provided for silicone filling and light cover fixing to protect the chip and allow a radiating nut to thread through the bottom of the chip cup screw for locking and positioning, the heat of the chip on the chip cup can transfer to the radiating nut below for effective and rapid industrial use of radiation.

(b) Description of the Prior Art

Present light bulbs exported are made by providing two conductive pin bridged Tungsten wire inside the traditional glass light housing, which are then energized so that the Tungsten wires generate light and energy. Although low-temperature LED lights have been developed and launched in recent years, the accompanying heat effect still causes the LED to decay excessively early, shortens its service life, therefore increasing the power consumption load of the user's system. Hence, it is highly necessary to improve this light bulb structure to make it perfect and practical.

### SUMMARY OF THE INVENTION

The primary purpose of the present invention is to provide a semi-conductor light, which refers to a semi-conductor light comprising a light cover, silicone, upper light housing, two conductive plates, lower light housing, conductive wires, chip, chip cup screw and radiating nut that enables effective and rapid radiation.

The secondary purpose of the present invention is to provide a semi-conductor light, which refers to the circuit board threaded through the bottom of the chip cup screw for locking and fastening with a radiating nut so that heat of the chip on the chip cup can be transferred to the nut below directly.

Another purpose of the present invention is to provide a semi-conductor light, which refers to silicone filled and light cover fastened above the light housing to protect the efficiency of the chip.

One more purpose of the present invention is to provide a semi-conductor light, which refers to the lower light housing enveloped in the head of the chip cup screw for arrangement of the two conductive plates, upper light housing, chip and conductive wires.

### BRIEF DESCRIPTION OF THE DRAWINGS

FIG. 1 is a drawing of preferred embodiment of the present invention

FIG. 2 is a 3D resolving drawing of the present invention

FIG. 3 is a 3D cross section view of the present invention

FIG. 4 is a cross section view of the present invention

FIG. 5 is the schematic of the screw locating block enveloped in the screw groove of the present invention.

FIG. 6 is the schematic of radiation function of the chip of the present invention.

### DETAILED DESCRIPTION OF THE PREFERRED EMBODIMENT

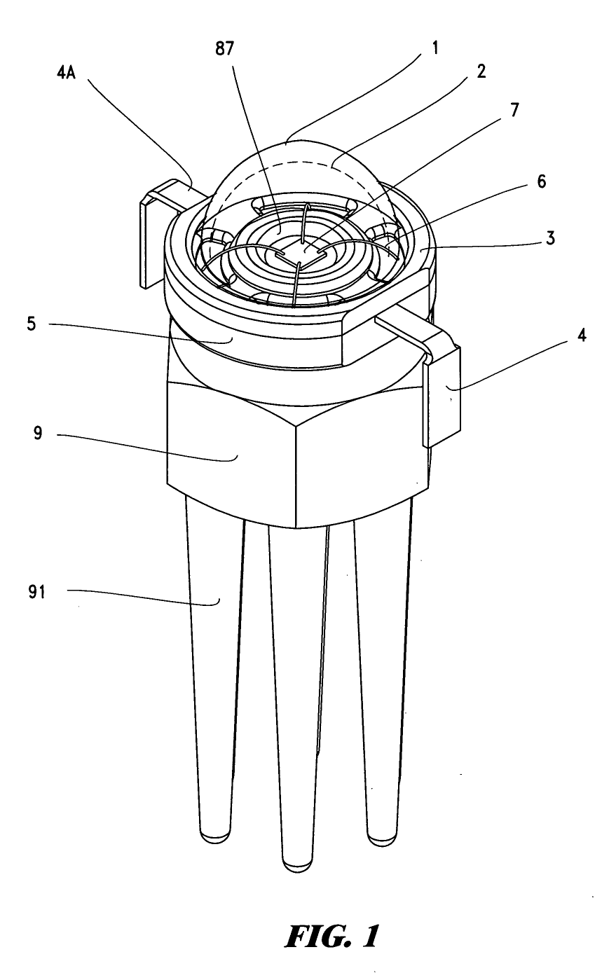

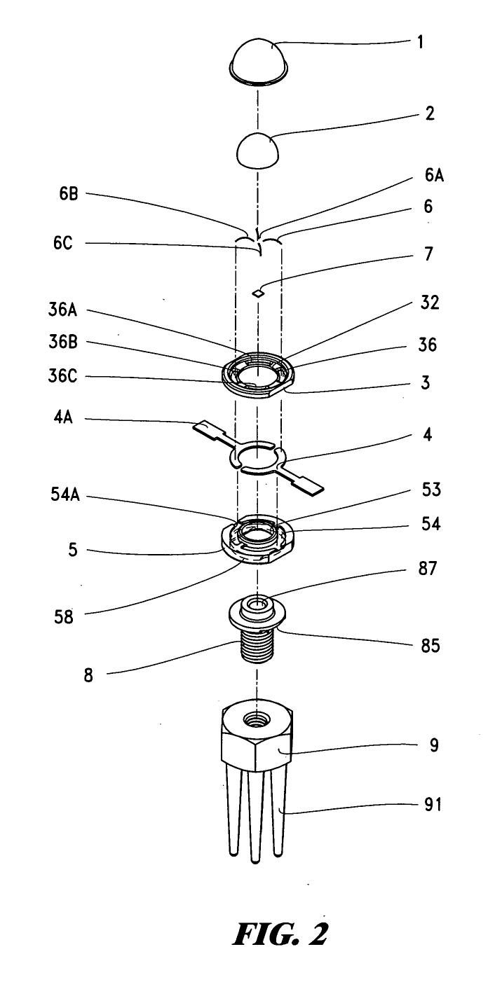

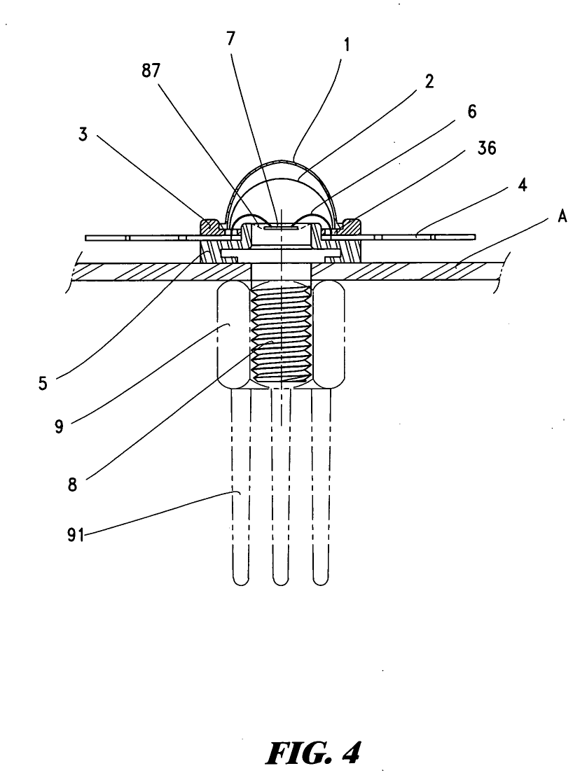

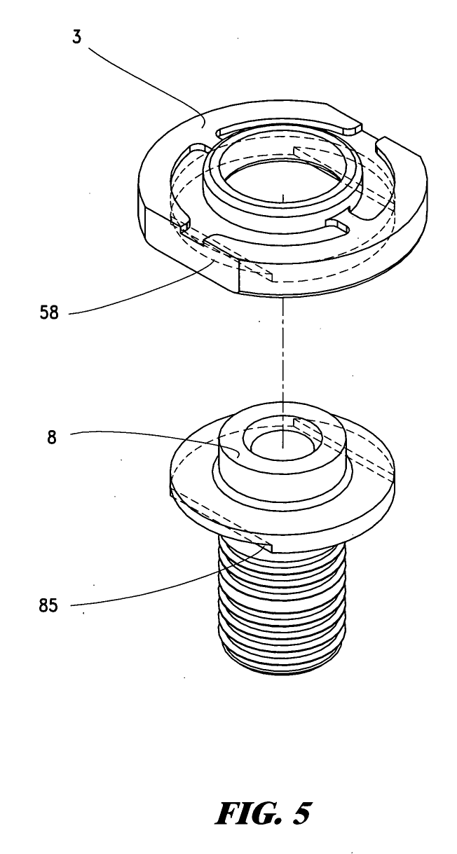

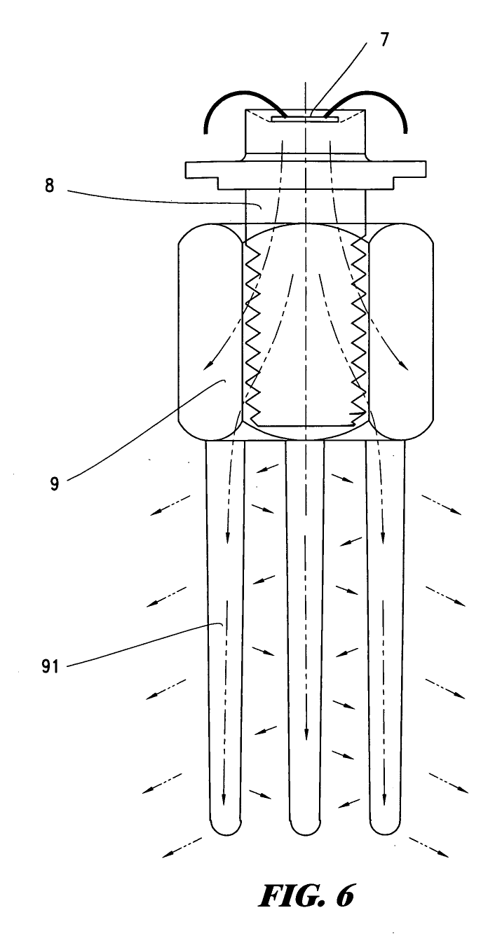

Referring to FIGS. 1 to 6, the present invention related to a radiating semi-conductor light, comprising a light cover 1, silicone 2, upper light housing 3, two conductive plates 4, 4A, lower light housing 5, conductive wire 6, chip 7, chip cup screw 8 and radiating nut 9. Light cover 1 is a semi-round cover made of transparent material, silicone 2 is a transparent silicone material, upper light housing 3 is a disk made of insulated material with a concave ring 31 for fixing the external ring below light 1 into place, the center of the concave ring is provided with a shaft hole 35, the radial face of the concave ring is provided with 4 equal elliptic holes 36, 36A, 36B and 36C, two conductive plates 4, 4A are two Y-shaped conductive plates with their front end in the semi-round shape, lower light housing 5 is a disk made of insulated material with a hollow shaft 53 bushing protruding from its center, its ring surface is provided with corresponding semi-round concave groove 54, 54A of conductive plate 4 and 4A for embedding of two conductive plates A, 4A and, fit and positioning of shaft hole 35 of upper light housing 3, the center of the bottom of the disk is provided with a screw groove 58, conductive wire 6, 6A, 6B, 6C are conductive wire bodies, chip 7 is a lighting semi-conductor chip, on top of which conductive wire 6, 6A, 6B and 6C are connected to the power supply, the other ends of the conductive electric wires pass through elliptic hole 36, 36A, 36B and 36C and connect to the semi-round conductive plates exposed in front of two conductive plates 4, 4A for conductance, chip cup screw 8 is a screw body made of heat conductivity material with a locating block 85 provided below the screw gasket so that the screw head faces toward screw groove 58 of lower light housing 5 for fixing, the top of the screw head is provided with chip cup groove 87 for seating and fastening for chip 7, radiating nut 9 is a nut made of heat conductivity material with several radiating blocks 91 extending below 5 for locking of chip cup screw 8, wherein silicone 2 is filled into conductive electric wire 6, 6A, 6B and 6C of light cover 1 and chip 7.

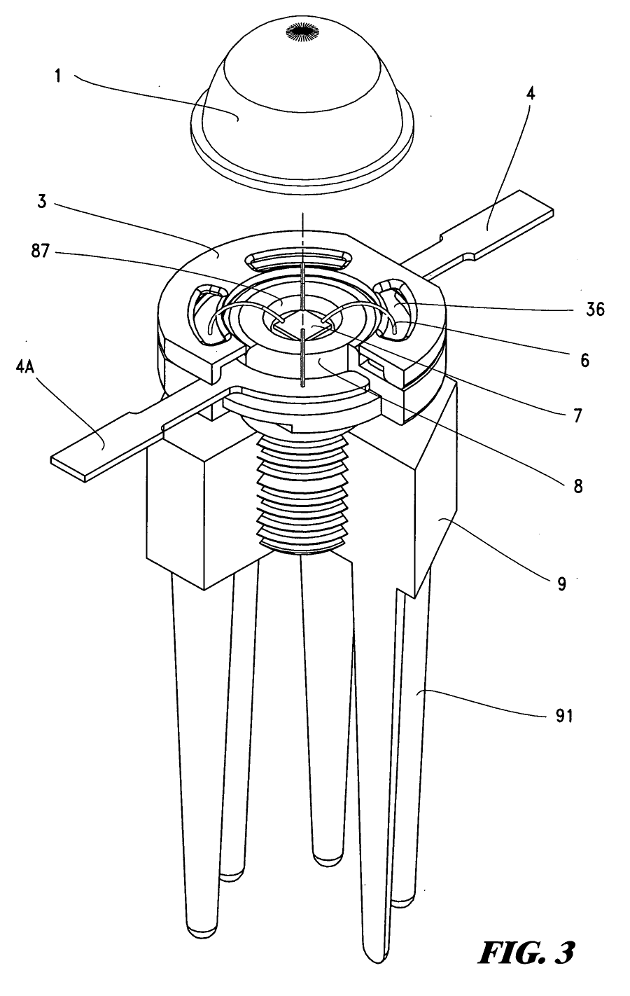

Please refer to FIGS. 3 to 6. It is an embodiment of the present invention. The head of the chip cup screw 8 is directly enveloped in screw hole 58 of lower light housing 5 so that two conductive plates 4, 4A, upper light housing 3 and chip 7 are enveloped with conductive wire 6, 6A, 6B and 6C, wherein concave ring 31 of the upper light housing is provided for silicone 2 filling and light cover 1 fastening to protect chip efficiency, chip cup screw 8 threads through circuit board A and positioned using radiating nut lock 9 so that chip 7 can transfer heat directly to several radiating blocks 91 of the radiating nut below to achieve effective and rapid industrial use of heat.

I claim:

1. A semi-conductor light, comprising
A light cover, which is a semi-round cover made of transparent material;
A silicone, which is a transmitting silicone material;
An upper light housing, which is a disk made of insulated material with a concave ring for fixing the silicone and light cover into place, the center of the concave ring is provided with a shaft hole, the radial face of the concave ring is provided with several equal elliptic holes;
Two conductive plates, which are two Y-shaped conductive plates with their front end in the semi-round shape;
A lower light housing, which is a disk made of insulated material with a hollow shaft bushing protruding from its center, its ring surface is provided with corresponding semi-round concave groove for embedding of two conductive plates and positioning of shaft hole of upper light housing, the center of the bottom of the disk is provided with a screw groove;
Several conductive wires are conductive wire bodies of excellent conductivity;
A chip, which is a lighting semi-conductor chip, on top of which conductive wires are connected to the power supply, the other ends of the conductive wires are connected to two conductive plates for conductance;
A chip cup screw is a screw body made of heat conductivity material with a locating block provided below the screw gasket so that the screw head faces toward the screw groove of lower light housing for fixing, the top of the screw head is provided with chip cup groove for seating and fastening;
A radiating nut, which is a nut made of heat conductivity material with several radiating blocks extending below for locking of the chip cup screw;
Wherein, the head of the chip cup screw is enveloped directly in the screw groove of the lower light housing for arrangement of two conductive plates, upper lamp housing, chip and conductive wires, the concave ring of the upper lamp housing is provided for silicone filling and lamp cover fixing to protect the chip and allow a locked radiating nut of the chip cup screw directly transfers the heat of the chip to the several radiating blocks to achieve effective and rapid radiation.
